(19) United States
(12) Patent Application Publication
(10) Pub. No.: US 2005/0149477 A1
(43) Pub. Date: Jul. 7, 2005

(54) Workstation and method for transforming information

(75) Inventor: Chih-Kang Chang, Taipei (TW)

Correspondence Address: HAVERSTOCK & OWENS LLP, 162 North Wolfe Road, Sunnyvale, CA, 94086, US

(73) Assignee: Power Geode Technology Co., Ltd.

(21) Appl. No.: 10/860,462

(22) Filed: Jun. 2, 2004

(30) Foreign Application Priority Data
Dec. 29, 2003 (TW) 092137355

(51) Int. Cl. G06F 7/00

(52) U.S. Cl. 707/1

(57) ABSTRACT

An information-transforming workstation for processing an object having a first identification information is provided. The information-transforming workstation includes a platform having an area for carrying the object thereon, a reading device for reading the first identification information and outputting a first signal, an image device for extracting respective images of the information-transforming workstation and the object, a signal-converting device for receiving the first signal and providing a second signal, and a printing device for receiving the second signal and printing a second identification information.

### FIELD OF THE INVENTION

This invention relates to a workstation and a method for transforming information, and more particularly to an information-transforming workstation and a method for processing an object having an identification information.

### BACKGROUND OF THE INVENTION

In the semiconductor industry, goods or materials such as front opening shipping boxes (FOSBs) which are transported from one company to another company generally have barcodes labeled by the former company. However, companies have different ways to express and to label the goods or the materials, so that the barcodes labeled on the goods or the materials have to be read and translated by the latter company. Traditionally, the operator in the latter company should take the barcode scanner on hands, scan the barcode on the goods or the materials one by one to identify the categories of the goods or the materials, then find out the corresponding barcodes in the latter company, print the corresponding barcode and label the corresponding barcode on the goods or the materials. It is very inconvenient for the operator in the latter company to repeatedly handle the barcode scanner.

Therefore, the present invention provides a workstation and a method for automatically transforming the identification information carried on goods to overcome the disadvantages of the prior art described above.

### SUMMARY OF THE INVENTION

It is an aspect of the present invention to provide a workstation and a method for automatically reading the identification information labeled on an object, so that there is no need for an operator to manually scan and to read the identification information.

In accordance with the aspect of the present invention, an information-transforming workstation is provided for processing an object having a first identification information. The information-transforming workstation includes a platform having an area for carrying the object thereon, a reading device for reading the first identification information and outputting a first signal, an image device for extracting respective images of the information-transforming workstation and the object, a signal-converting device for receiving the first signal and providing a second signal, and a printing device for receiving the second signal and printing a second identification information.

Preferably, the first identification information is a barcode.

Preferably, the first signal is generated in response to the first identification information and the second identification information is generated in response to the second signal.

Preferably, the information-transforming workstation further includes a reflecting sensor for detecting whether the object enters the platform and for activating the information-transforming workstation to process the object when the object enters the platform.

Preferably, the information-transforming workstation further includes a display, wherein the respective images of the information-transforming workstation and the object are shown on the display, and thereby the workstation and the object are monitored.

Preferably, the reading device is an optical identification system having a multi-beam laser and a scanning device.

Preferably, the scanning device has a read head.

Preferably, the image device has two cameras for generating a top view and a side view of the object, respectively.

Preferably, the top view and the side view are remotely monitored.

Preferably, the signal-converting device is a computer having a first software for reading the first signal and selecting the second signal from a database of the computer.

Preferably, the computer is a multiplex controller and the first software is further used for comparing the first signal with the database, thereby selecting the second signal.

Preferably, the first software is programed to read signals from twelve barcodes at a time and the computer is connected to an application server and a database server for a user terminal.

Preferably, the database of the computer is synchronously transmitted via a wireless local area network (LAN).

Preferably, the wireless LAN is connected to a data collector having a second software, and the database is transmitted by the second software.

Preferably, the computer is used as an optical data collection detector for transforming the database into an enterprise resource planning (ERP) system.

Preferably, the information-transforming workstation is modulized and has a function of automatic error detection.

Preferably, the printing device is an identification information printer and has a window for monitoring a usage of paper for being printed as the second identification information.

Preferably, the second identification information is a barcode and the identification information printer is a barcode printer.

It is another aspect of the present invention to provide an information-transforming workstation for processing an object having a identification information, including a platform having an area for carrying the object thereon, a reading device for reading the barcode and outputting a identification information, and a signal-converting device for receiving the first signal and providing a second signal.

It is another aspect of the present invention to provide an information-transforming workstation for processing an object having a identification information, including a platform having an area for carrying the object thereon, and a signal-converting device for reading the identification information, decoding the identification information to generate a signal and outputting the signal.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view showing an information-transforming workstation according to the preferred embodiment of the present invention;

FIG. 2 is a schematic view showing a reading device according to the preferred embodiment of the present invention;

FIG. 3 is a schematic view showing an optical identification system according to the preferred embodiment of the present invention; and

FIG. 4 is a schematic view of an information-transforming workstation according another embodiment of the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

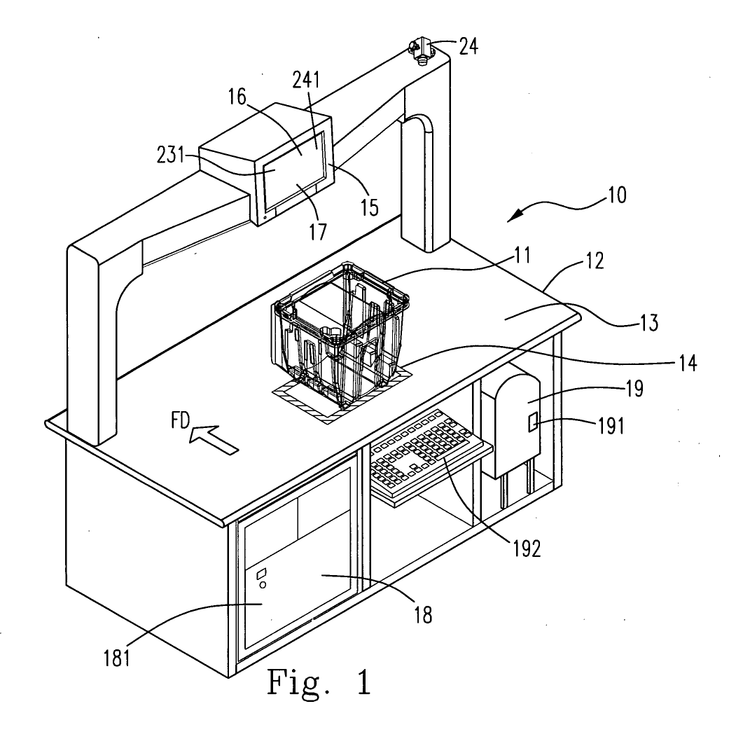

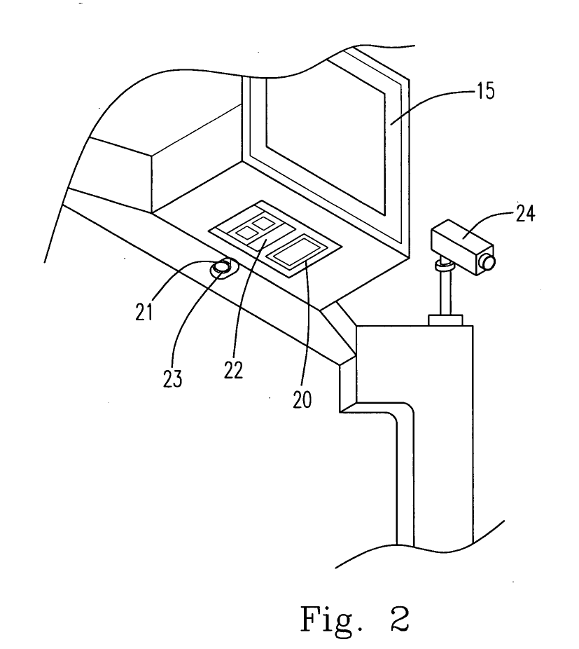

Please refer to FIGS. 1 and 2. An information-transforming workstation 10 is provided for processing an object 11 (such as a FOSB) having a first identification information (such as a barcode) and for transforming the identification information. The information-transforming workstation 10 includes a main body 12, a platform 13 disposed on the main body 12 and having an area 14 for carrying the object 11 thereon, a display 15 disposed on the main body 12, a reading device 20 disposed on the main body 12 and used for reading the first identification information and outputting a first signal, an image device 21 for extracting respective images of the information-transforming workstation 10 and the object 11, a signal-converting device 18 for receiving the first signal and providing a second signal, and a printing device 19 for receiving the second signal and printing a second identification information. The information-transforming workstation is provided for transforming the first identification information carried on the object into the second identification information, wherein the first signal is generated in response to the first identification information and the second identification information is generated in response to the second signal.

The information-transforming workstation 10 further includes a reflecting sensor 22 as shown in FIG. 2 for detecting whether the object 11 enters the platform 13 in the direction of FD and for automatically activating the information-transforming workstation 10 to process the object 11 when the object 11 enters the platform 13. Since the information-transforming workstation 10 can be automatically activated to process the object 11, there is no need to use a keyboard 192 for activating the reading device 20.

The respective images of the information-transforming workstation 10 and the object 11 are shown on the display 15, so that the workstation 10 and the object 11 can be monitored. The reading device 20 can be an optical identification system having a multi-beam laser and a scanning device (not shown). According to the preferred embodiment in FIGS. 1 and 2, the image device 21 includes cameras 23 and 24 for respectively generating a top view 231 and a side view 241 of the object 11 shown on the display 15. Therefore, the object 11 can be remotely monitored. The signal-converting device 18 is a computer 181 having a first software for reading the first signal and selecting the second signal from a database of the computer 181, wherein the second signal is in response to the first signal. Preferably, the first software is programmed to read signals from twelve barcodes at a time. The scanning device 20 further has a read head (not shown).

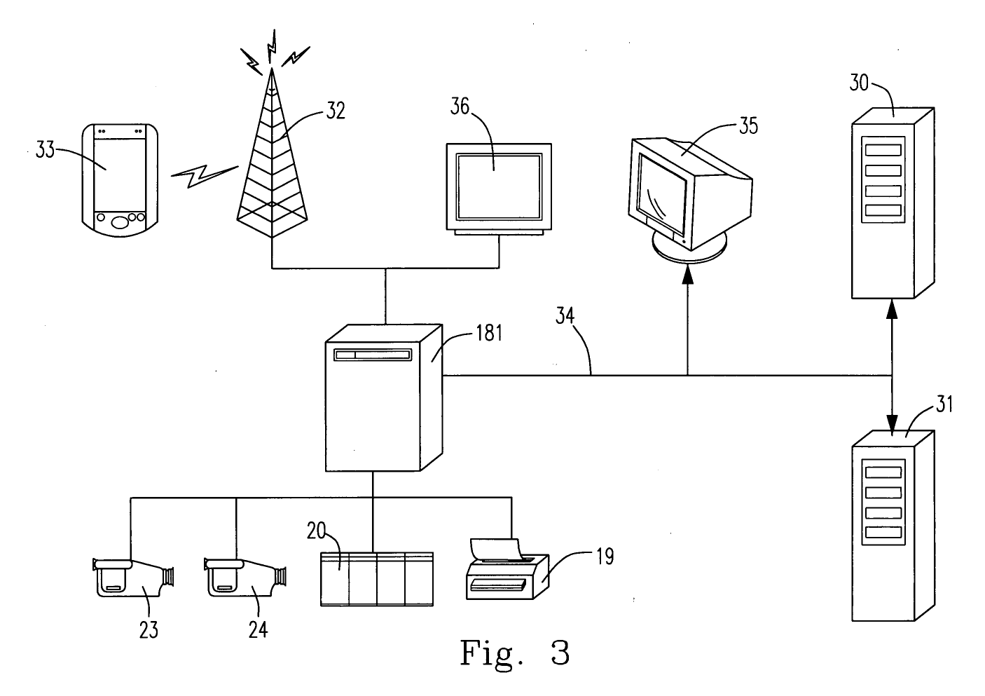

Please refer to FIG. 3. The computer 181 is connected to an application server 30 and a database server 31 for a user terminal. The computer 181 is a multiplex controller (not shown), and the first software is further used for comparing the first signal with the database, thereby the second signal is selected. The database of the computer 181 is synchronously transmitted via a wireless local area network (LAN) 32, wherein the wireless LAN is connected to a data collector 33 having a second software, and the database is transmitted by the second software. The computer 181 can be an optical data collection detector (not shown) for transforming the database into an enterprise resource planning (ERP) system. Preferably, the information-transforming workstation 10 is modulized and has a function of automatic error detection. In addition, the printing device 19 is an identification information printer and has a window for monitoring a usage of paper for being printed as the second identification information. Preferably, the printing device 19 is a barcode printer for printing a barcode carrying the second identification information.

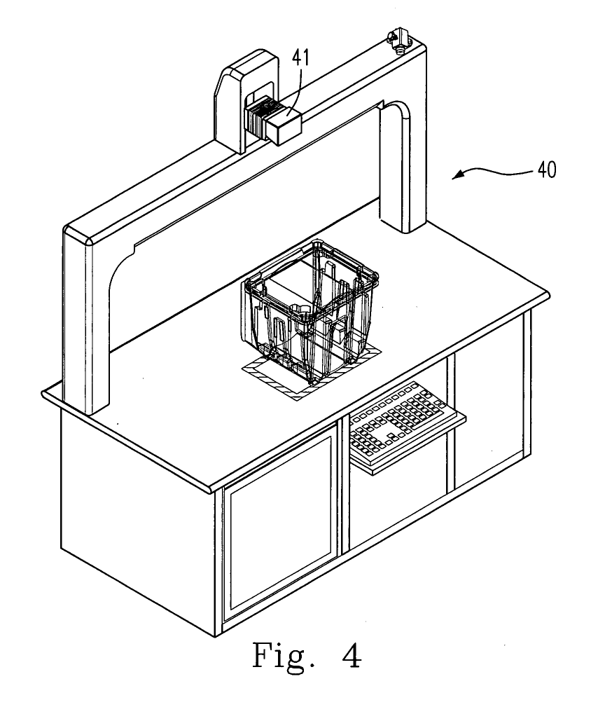

Please refer to FIGS. 3 and 4. The information-transformation workstation 40 includes a keyboard 192 for activating a reading device 41 and further includes a touch interface 36 for an operator.

In another embodiment of the present invention, an information-transforming workstation for processing an object having an identification information includes a platform having an area for carrying the object thereon, a reading device for reading the barcode and outputting a identification information, and a signal-converting device for receiving the first signal and providing a second signal.

Since the reading device can be integrated into the signal-converting device, an information-transforming workstation in another preferred embodiment includes a platform having an area for carrying the object thereon, and a signal-converting device for reading the identification information, decoding the identification information to generate a signal and outputting the signal.

In conclusion, the present invention provides an information-transforming workstation for automatically transforming a first identification information carried on an object into a second identification information. There is no need for an operator to manually scan the objects one by one. In addition, the information-transforming workstation further includes an image device for generating views of the objects, so that the objects can be remotely monitored.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An information-transforming workstation for processing an object having a first identification information, comprising:
a platform having an area for carrying said object thereon;
a reading device for reading said first identification information and outputting a first signal;
an image device for extracting respective images of said information-transforming workstation and said object;
a signal-converting device for receiving said first signal and providing a second signal; and
a printing device for receiving said second signal and printing a second identification information.

2. The information-transforming workstation according to claim 1, wherein said first identification information is a barcode.

3. The information-transforming workstation according to claim 1, wherein said first signal is generated in response to said first identification information and said second identification information is generated in response to said second signal.

4. The information-transforming workstation according to claim 1 further comprising a reflecting sensor for detecting whether said object enters said platform and for activating said information-transforming workstation to process said object when said object enters said platform.

5. The information-transforming workstation according to claim 1 further comprising a display, wherein said respective images of said information-transforming workstation and said object are shown on said display, and thereby said workstation and said object are monitored.

6. The information-transforming workstation according to claim 1, wherein said reading device is an optical identification system having a multi-beam laser and a scanning device.

7. The information-transforming workstation according to claim 5, wherein said scanning device has a read head.

8. The information-transforming workstation according to claim 1, wherein said image device has two cameras for generating a top view and a side view of said object, respectively.

9. The information-transforming workstation according to claim 7, wherein said top view and said side view are remotely monitored.

10. The information-transforming workstation according to claim 1, wherein said signal-converting device is a computer having a first software for reading said first signal and selecting said second signal from a database of said computer.

11. The information-transforming workstation according to claim 10, wherein said computer is a multiplex controller and said first software is further used for comparing said first signal with said database, thereby selecting said second signal.

12. The information-transforming workstation according to claim 10, wherein said first software is programed to read signals from twelve barcodes at a time and said computer is connected to an application server and a database server for a user terminal.

13. The information-transforming workstation according to claim 10, wherein said database of said computer is synchronously transmitted via a wireless local area network (LAN).

14. The information-transforming workstation according to claim 10, wherein said wireless LAN is connected to a data collector having a second software, and said database is transmitted by said second software.

15. The information-transforming workstation according to claim 10, wherein said computer is an optical data collection detector for transforming said database into an enterprise resource planning (ERP) system.

16. The information-transforming workstation according to claim 1, wherein said information-converting workstation is modulized and has a function of automatic error detection.

17. The information-transforming workstation according to claim 1, wherein said printing device is a identification information printer and has a window for monitoring a usage of paper for being printed as said second identification information.

18. An information-transforming workstation for processing an object having a identification information, comprising:
a platform having an area for carrying said object thereon;
a reading device for reading said barcode and outputting a identification information; and
a signal-converting device for receiving said first signal and providing a second signal.

19. An information-transforming workstation for processing an object having a identification information, comprising:
a platform having an area for carrying said object thereon; and
a signal-converting device for reading said identification information, decoding said identification information to generate a signal and outputting said signal.
